(19) United States
(12) Patent Application Publication
(10) Pub. No.: US 2005/0240294 A1
(43) Pub. Date: Oct. 27, 2005

(54) Golf shot recording system

(76) Inventors: George P. Jones, Fishers, IN (US); Craig M. Oxendine JR., Fishers, IN (US); Matthew T. Goddard, Carmel, IN (US)

Correspondence Address: Christopher E. Haigh;BANIAK PINE & GANNON, Suite 1200, 150 N. Wacker Drive, Chicago, IL, 60606-1606, US

(21) Appl. No.: 10/832,681

(22) Filed: Apr. 27, 2004

(51) Int. Cl. G06F 155/00

(52) U.S. Cl. 700/92

(57) ABSTRACT

A recording system for data related to a game is disclosed. A game player can record his/her data and have the data input via an input device. The input device can be used to communicate with a central repository which can store data on a plurality of games and a plurality of venues.

### BACKGROUND OF THE INVENTION

The present invention relates to a system for recording the score of a game, and particularly to a system for recording the score and performance of a golfer.

Golf pros have traditionally relied upon a hands-on assessment of a golfer in order to determine what weaknesses a golfer may have in his or her game. Typically, the golf pro would watch the golfer hit a number of golf balls either at a driving range or on a golf course over the course of a number of holes.

More recently, golf shot recording systems have emerged that allow a golfer to track various aspects of the golfer's performance during a game by writing data on a golf scorecard during the game. As used herein, the word data may refer to any information or statistics that can be recorded relating to a game. In the illustrative embodiment, the card may have data-entry areas designated for recording greens in regulation, fairways hit, shots left, shots right, penalties, traps (tee shot, fairway, approach), putts, averages on all statistics (average putts, average greens in regulation, etc.), club selection for each shot, ball used (manufacturer, density, classification, etc.), weather conditions, physical and/or health conditions, yardage per club, and average shots per par 3, par 4, par 5, etc. Of course, any other statistic or information that is desirably monitored can be recorded on a specially-designed card.

### SUMMARY OF THE INVENTION

The present invention includes one or more of the following features or combinations thereof:

A golf shot tracking system in which a data entry element is used to record data is desired. In one preferred embodiment, the data entry element may take on the tangible form of a scorecard. The scorecard may have data entry portions. An input device can be configured to read data from the scorecard. An output device can be configured to report all or selected data read from the scorecard. Data may be stored in a user-specific device or in a database or central repository that is accessible via the Internet, intranet, extranet, WAN (Wide Area Network), or LAN (Local Area Network), can also be used to store selected data that was read from the scorecard.

The data may be collected in a database accessible from one or more locations; the database can be configured to store data relating to the golf course at which the data was obtained. The database may be configured to store data from a plurality of golf courses.

An identification device by which a user may identify him or herself or by which the user may be identified may be used to identify the particular user and/or golfer. The identification device can permit the user to enter his or her name and gain access to the system—either automatically or after proceeding through a security check process. The identification device can also be a fingerprint scanner, facial recognition system, a biometric scanner, a magnetic-strip card reader, an RF receiver for receiving signals from an RF transmitter, a signal receiver for receiving signals from a signal transmitter, sequence of numbers and/or characters on the back of the score card, and/or a code input device.

The input device may be an optical scanner, a PDA (Personal Digital Assistant) or other handheld electronic device that provides communications capability, such as a cell phone, an electronic scoring device, and/or a GPS (Global Positioning System) device. The output device may be a printer, a terminal, a computer, wireless transmission to another device, and/or a display.

A processor may be used to collect data received from the input device and arrange the data in a pre-determined fashion for outputting with the output device. The processor may also direct data to the Internet-accessible database.

Additional features of the invention will become apparent to those skilled in the art upon consideration of the following detailed description of preferred embodiments exemplifying the best mode of carrying out the invention as presently perceived.

The system may also include an element by which images of the subscriber, such as while at the terminal or at various places on the golf course, may be captured. A digital camera could be attached to the device in order to capture the user's picture and associate the person's picture with the appropriate golf round data.

The system may also be used to print coupons and other incentives to be delivered to the golfer upon scanning their completed golf card through the system. The printout each user receives for every round played can include coupons, discounts or other incentives from a local or national source. This option fits well with other advertising opportunities related to the system discussed herein.

### BRIEF DESCRIPTION OF THE DRAWINGS

The detailed description particularly refers to the accompanying figures in which:

FIG. 1 is an illustrative golf shot tracking card for use with the golf shot tracking system;

FIG. 2 shows an illustrative questionnaire for use with the golf shot tracking system; and

FIG. 3 shows various components that can be used in the golf shot tracking system.

### DETAILED DESCRIPTION OF THE DRAWINGS

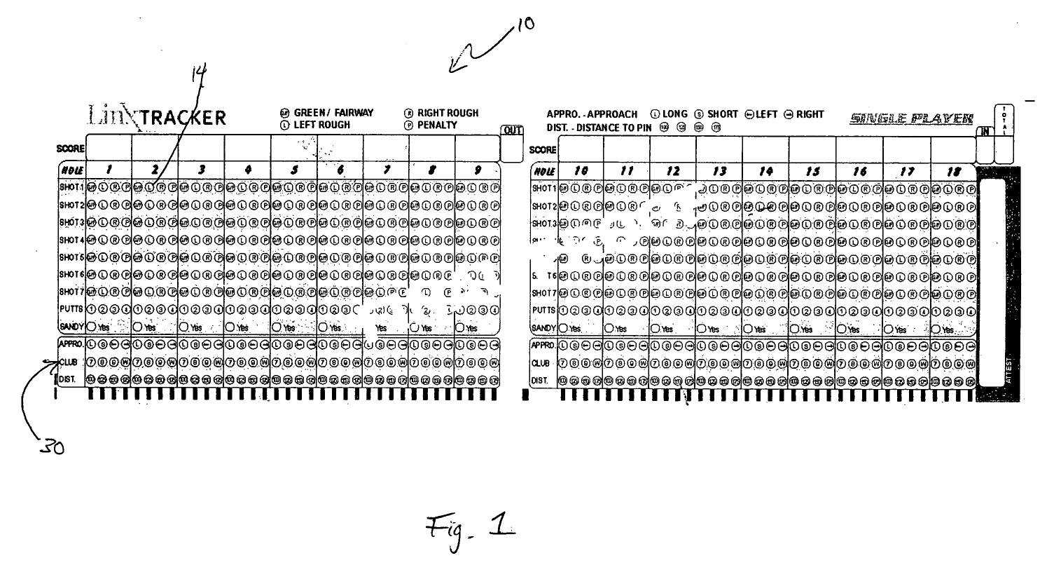

As can be seen in FIG. 1, a scorecard or card 10 (illustratively configured for the game of golf) provides fill-in blanks relating to a golfer's performance during a golf game. The scorecard 10 may be in a tangible form such as a printed paper card or electronic such as the display screen on which data may be entered. In the illustrative printed paper card, fill-in blanks are circular “bubbles”; however, it should be understood that other configurations and scoring systems are within the scope of the disclosure. For example, chad systems, hand-written systems, electronic recording systems, or any other system that records a golfer's performance for later analysis can be used in conjunction with the present invention.

The illustrative scorecard 10 is specifically designed to be accepted and read by a scanner, described further herein. The card is limited only by the dimensions that are acceptable to any particular scanner. Examples of some of the data and information that can be tracked via the scanable card include:
A. Golf Games (including but limited to)
   a. Bingo Bango Bongo
   b. Bridge
   c. Chairman
   d. Greenies
   e. Las Vegas
   f. Low Ball-Low Total)
   g. Low Ball-High Ball
   h. Nassau
   i. Nines
   j. Round Robin (6, 6 and 6)
   k. Scramble
   l. Shamble
   m. Skins
   n. Trifecta
   o. Twosome Best Ball
   p. Wolf
   q. 3 in 1
   r. 6-4-2-0
   s. Stableford
B. Individual Shot by Shot Statistics (Examples include but are not limited to)
   a. Greens in regulation
   b. Fairways hit
   c. Shots Left
   d. Shots Right
   e. Penalties
   f. Traps (Tee shot, Fairway, Approach)
   g. Putts
   h. Averages on all statistics (average putts, average greens in regulation, etc.)
   i. Club selection for each shot
   j. Ball used (manufacturer, density, classification, etc.)
   k. Weather conditions
   l. Physical and/or Health conditions
   m. Yardage per club
   n. Average shots per par 3, par 4, par 5, etc.
C. Group Shot by Shot Statistics (Twosome, Foursome) (Same as Individual)
D. Single Site Tournament Scoring and Data Tracking
   a. Leaderboard Statistics
   b. Low Gross, Low Net (of Handicap)
   c. Same stats at Individual
E. Multiple Site Tournament Scoring and Data Tracking (Same as Single Site)
F. Virtual Tournament Scoring and Data Tracking
G. Single Site League Scoring and Data Tracking
H. Multiple Site League and Data Tracking
I. Virtual League and Data Tracking
J. Special Event Scoring and Data Tracking (Outings, Scrambles, Charity Events)

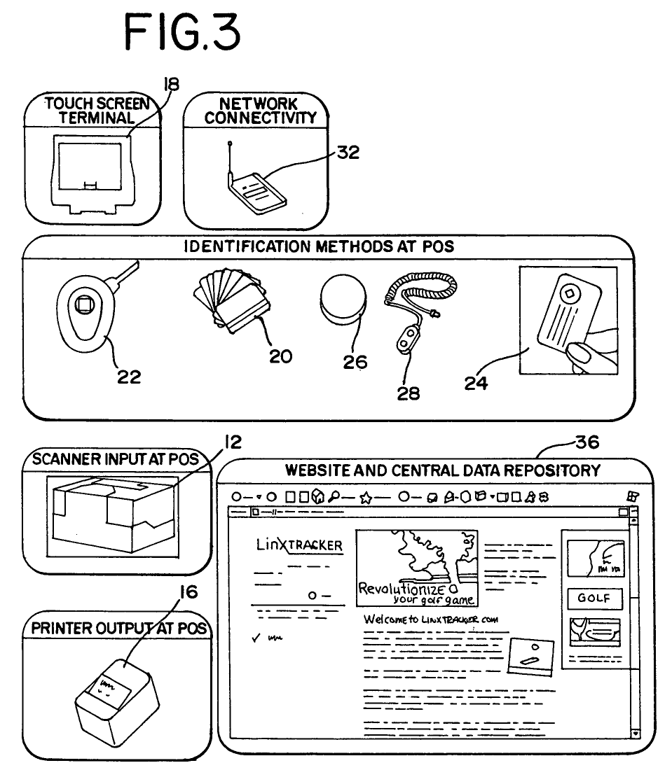

If in tangible printed form, the illustrative scorecard 10 is specifically designed to be read by an Optical Mark Reader (OMR) scanner 12, shown in FIG. 3, using either visible red or infrared technologies. The illustrative scorecard 10 measures 14 inches long and 3¼ inches wide, and is printed on specialized scanner paper that is eraser-resistant, weather-resistant, and durable. The card layout consists of multiple bubbles 14 patterned over a plurality of rows and columns. The card captures individual shot by shot per hole data, as discussed further herein. Sample individual shot by shot data captures may include, but are not limited to:
a. Greens in regulation
b. Fairways hit
c. Shots Left
d. Shots Right
e. Penalties
f. Traps (Tee shot, Fairway, Approach)
g. Putts
h. Averages on all statistics (average putts, average greens in regulation, etc.)
i. Club selection for each shot
j. Ball used (manufacturer, density, classification, etc.)
k. Weather conditions
l. Physical and/or Health conditions
m. Yardage per club
n. Average shots per par 3, par 4, par 5, etc.
o. Type of clubs used (Manufacturer)
p. Health conditions on the date of play.

A computing system, screen (if card is electronic in form) or processor is also disclosed (but not shown). The processor can receive data from scanner 12 and send and receive data to the central repository system (or central database) via the Internet, intranet, extranet, WAN (Wide Area Network), or LAN (Local Area Network). Once data is compiled, it can also be output to other types of devices, discussed in more detail below.

An output device, such as printer 16, shown in FIG. 3, may produce generic and user-specified statistical reports. Such an output device may alternatively or additionally comprise a database at the golfer's golf course; an electronic display; a television; an electronic mobile device, including PDAs, Laptop PCs, Tablet PCs, mobile phones, mobile phones/PDAs combinations, etc.; and a residential or business PC.

By utilizing such a system at a plurality of golf courses, large amounts of data may be obtained, organized, and maintained on a shot-by-shot basis. This data is invaluable not only to the golfer but also could be invaluable to organizations like the USGA (United States Golf Association), major merchandisers (Nike Golf, Titlelist, Taylor Made, Callaway, etc.) and other groups who require specific demographic data. Such data will allow for merchandisers to view relevant statistics such as equipment utilization, percentage of straight shots with a certain golf club, number of golf clubs/balls/etc. in use by a certain manufacturer, etc. Demographic trends and analysis data on the golf industry may also be utilized or sold.

The illustrative golf shot recording system includes a centralized database for housing, maintaining, updating, and publishing user data from remote and/or other sources. The system may comprise a golf card, user identification system, a scanner or other input device, a printer or other output device, an electronic screen (touch screen), a method to connect to the Internet (constant OR periodic connection), intranet, extranet, WAN (Wide Area Network), or LAN (Local Area Network), centralized database to house data and a website for user access via the Internet, intranet, extranet, WAN (Wide Area Network), or LAN (Local Area Network).

A subscription-based service may be utilized to allow golfers to sign up for an account to track shot by shot statistics related to their various golf rounds over time. Various statistics can be tracked by individual golfers that will allow users to quickly pinpoint the weak areas of their game to target for improvement.

User identification systems may include any of the herein-described methods of identifying the particular user, however, it should be understood that other identification systems are within the scope of the disclosure. Ideally, the identification system can uniquely identify each golfer on the system.

Illustratively, a magnetic strip card reader is shown on a user terminal 18 in FIG. 3. With such a system, a credit card sized identification card 20 can uniquely identify each golfer. The magnetic cards 20 will be available to users via golf pro shops, retail shops and other locations that support the disclosed system. The cards can be offered on consignment or for direct sale via a point of sale unit. The magnetic ID cards can also be sent to new users via welcome packets.

There are many additional uses for a magnetic identification card. One use may be as a golf rewards tracking mechanism that would provide golfers various incentives and perks based on the number of rounds they play. Additionally, the membership/identification card could double as a credit and/or debit card. It could also be a Smart Card that would allow the golfer to carry monetary credits on the card along with other valuable information for various uses. Smart Cards typically provide the ability for much more functionality than a standard magnetic stripe card.

Another way to identify users is via a biometric device. Biometric devices include fingerprint technologies, retinal scan, facial recognition and other uniquely identifying tests that rely on a person's biometric make-up to identify each user. The golf shot recording system has the capability to use biometrics to identify members. An illustrative fingerprint reader 22, shown in FIG. 3, may be purchased at Precise Biometrics at http://www.precisebiometrics.com/products.asp?FIRSTLEVELID=20020624_{—}141537_{—}51337941&GROUPID=27062002_{—}141206_{—}51126711)

Other identification system may include the use of Radio Frequency tags (RF tags) 24, bar coded identification (membership cards, bag tag, etc.), username/password/login via the touch screen terminal 18 (which would eliminate the need for any extraneous equipment), an iButton 26, and any other identification techniques that may be developed in the future. The Pacific Northwest National Laboratory is a manufacturer of some identification devices, and more information can be obtained at http://www.technet.pnl.gov/sensors/electronics/projects/es4indsen.html) and http://availabletechnologies.pnl.gov/securityelectronics/rftags.stm).

The iButton 26 technology is similar to a smart card in that iButtons hold the ability to store data in memory and automatically read the data on contact. This method of identification goes beyond simply recognizing the individual and would have the potential for additional services such as storing and retrieving data (golf related or otherwise), providing a method for tracking golfer behavior and providing rewards, can be built into a clock or watch to provide a timepiece for an individual, has the ability to record temperature, can be password protected, etc.

The current technology available in the form of an iButton that would work in its basic form to uniquely identify users is the iButton EEPROM-DS1971 256 bit EEPROM iButton. This iButton has read/write capability and have a general usage span of approximately 10 years. Another example of an iButton that would integrate with the golf shot recording system is the iButton model DS16997L-64 kb NV RAM iButton. This iButton is also read/write and has the capability to be re-written millions of times. All iButtons have a unique and unalterable factory-lasered address, and have the ability to operate as a mobile database in either stand alone or networked application designs. Additional information on the iButton technology can be found at http://www.ibutton.com. An iButton reader 28 is also shown in FIG. 3.

As disclosed above, a user could also enter a membership number on a touch screen terminal 18 or keyboard at the point of sale. This would allow the user to be able to enter a username/password combination to enter the system as opposed to swiping a membership card or using some other identifying device. Once authenticated, the user can then access the recording system and scan their completed card 10 or otherwise transmit their data.

Security measures may be employed to protect data and to protect users. As an added layer of security and for historical tracking of users while on the course (or otherwise) GPS (Global Positioning System) technology can be built into the system to allow for the system to automatically track golfer distances to the pin as the golfer takes each stroke. There may be other relevant uses for GPS technology with relation to the system that will become apparent as technological advances open up new possibilities. This functionality may fit hand in hand with the iButton technology (or something similar) in the future.

Once a user signs up for the tracking/recording service, a magnetic ID card they choose (or other identification means) will be associated with their account. In the sign-up procedure herein described, the user will be prompted to insert a pre-programmed magnetic ID card in to the system. The unique ID on the magnetic ID card will be identified. Since the user account will not yet be active, the user will be prompted to activate an account by going through the activation procedure. The user will then be guided through a series of screens that will prompt the user to enter their name, address, phone, email, username and password. Finally, the user will be prompted to enter a valid credit card for processing of the annual subscription fee. Upon verification and acceptance of the credit card payment, the user information will be uploaded to the central repository. The username and password will be verified for uniqueness. If a conflict occurs, the user will then be prompted to choose a different username and/or password until an acceptable format and unique combination is selected. This process will continue until all data is verified and accepted by the central repository.

Once the user account has been activated, the user may use the magnetic ID card 20 (or other identification means) to automatically identify himself at any other golf course terminal by swiping their magnetic ID card. The user may be required to verify his/herself via unique password once he swipes his card at the terminal in order to expedite the transaction time for the user. In the case where the user has lost or misplaced the card 20 the user will be able to login manually to the system, as described further herein.

The pre-programmed magnetic ID cards can also be prepackaged and sold (direct, consignment, etc.) through retail shops. This will allow people to purchase accounts for the service when they are outside of the pro shop or away from their computer. Retail shops such as golf specialty shops (in the U.S., Golf Galaxy, Nevada Bob's Golf, etc.) are a logical fit for this type of delivery. Alternate channels include retail shops like Target, WalMart, Meijer, and other conglomerates. Because the magnetic ID cards are pre-programmed, the specific lots and batches associated with each retailer will be managed via the central data repository. The pre-programmed magnetic ID cards will be added as a Stock Keeping Unit (SKU) at the retail locations and sold through the retail location via a standard point of sale transaction. Sales transaction reports (daily, weekly, monthly, quarterly, and/or annual) will be required for all retail transaction history. This will allow proactive management of the card re-order process and account setup. In this instance, the user will pay for the account via the retail purchase procedure (checkout line, etc.).

Once an account has been purchased through a retail channel, the end user will be directed to activate their account either online via the Internet at a website, or at a participating golf course. If the user chooses to activate the account online, the user will illustratively access the website (http://www.linxtracker.com) and select the ‘Activate New Account’ section. The user will then be prompted to enter the unique code presented on the pre-programmed magnetic ID card. This unique code will be recorded in the user account as well as the central repository to allow credit for the retail establishment as well as auditing of all active accounts and transaction history. The central repository will recognize the unique code as a paid account and will allow the user to continue the activation process. The user will then be prompted to enter all relevant account information (name, address, phone, email, username and password) to activate the account. Once all information is verified and accepted by the system, the user will be notified that his/her account has been properly activated. The user may now visit any participating golf course to automatically score their golf rounds.

If the user chooses to register their account via a participating course, the user will swipe his/her card at the terminal 18. The card will automatically be identified as an account that was purchased through a retail channel. In real time, the system will query the central repository to check the account status for the particular card. The system will have the ability to ‘flag’ individual and or groups of accounts as invalid in the case that magnetic ID cards or other identification means are stolen from a retail location, from an individual, at a golf club or at any other location related to the system. If it is determined that the account is a valid retail account, then the user will be prompted to enter the appropriate information to activate their account (name, address, phone, email, username and password). The system will verify the uniqueness of the username and password combination against the central repository then return acceptance or prompt the user to choose a different username and password combination until a unique selection is accepted. Once the user account has been verified the account is considered active and the user may use the system.

The system can also allow users to manually enter their username and password via the touch screen terminal in the pro shop. This is to allow for the instances where members may have forgotten or misplaced their magnetic ID card or other identification means. The user will select the appropriate login selection via the touch screen terminal and will be prompted to enter their username and password. The user will click the appropriate letters and numbers via a virtual keyboard that will present itself via the touch screen terminal, or physical keyboard or other input device. Upon successful entry of the username and password, the user will be authenticated and then granted or denied access based on the status of their account.

Temporary accounts may also be provided to potential users in which users can ‘try before you buy’. This would allow potential customers to utilize the system and evaluate its value prior to paying for any subscription.

Such a system may be integrated with the United States Golf Association (USGA) and the Golf Handicap Information Network (GHIN). The GHIN system is currently in use at approximately 9,100 golf facilities and has a user base of approximately 4.5 Million members. The presently disclosed system could replace the current GHIN equipment on hand at the various golf courses. The user will follow the standard GHIN rules to establish a handicap and setup a GHIN account with their local course. The presently disclosed system can be a value-added service that is tied to the GHIN service. The system will allow the GHIN system to capture, track and store shot by shot golf statistics for every one of their members across the country.

Users may also have the ability to sign up for a subscription via the Internet, via the pro-shop or other point of sale (“POS”) opportunity, and/or via telephone. Users will be required to pay for a one year subscription in advance and will have the benefit of using the system throughout the year (this could also be billed in different ways such as per round, monthly, quarterly, etc.). Ultimately, all user accounts will be assigned and tracked via the central data repository in order to eliminate the possibility of duplicate accounts and for data and user integrity. Each user will be assigned a unique identification username and password to access the system. This will provide a unique identification system that will allow subscribers to be associated with one specific course (home course) and to be recognized at each and every course that implements the service.

A user may alternatively initiate the registration process via the terminal 18 in the Pro Shop by selecting the appropriate area on the display (touch screen, keyboard, Point of Sale system, etc.). The system will prompt the user to input the following items: First Name, Last Name, Select Username, and Select Password. Upon successful input of this information, user will be prompted to pay via credit card (or other immediate, electronic payment method) to initiate service and activate their account. User will slide their credit card through the card reader (this could also be processed through the pro shop POS system if the pro so desired) for processing or will enter their credit card via a touch screen, keypad, keyboard or other device or means. The credit card verification process will be initiated by connecting to the appropriate credit institution(s) and will return an authorization or denial based on the user's available funds and/or credit. Connectivity for the credit card verification process can be a wired telephone connection, a wireless telephone connection, an Internet connection (periodic or perpetual), etc.

Once payment has been accepted, the user information is uploaded and verified on the system. The user is then prompted to insert one of the pre-programmed magnetic ID cards (or other identification means). The unique ID on the illustrative magnetic ID card is associated with the newly created user account.

Once a user logs in they should have the ability to set certain preferences (change password, etc.). The membership ID could be the username for each user.

Temporary members may also be accommodated. Temporary members will be sequentially (or randomly) assigned temporary member IDs that will be tracked by the relational database. Upon receiving this temporary member ID and password the prospective member will be able to run and/or automatically print a scaled down version of the full blown member statistical report. This scaled down version of the report may give hole by hole score and totals but may not give specific statistics that full members would see with every round they play. The scaled down report should also be heavily concentrated toward driving that temporary member to sign up for a full membership. The benefits that should be communicated to the temporary member should be:
1. Automatically track all rounds played on participating courses.
2. View standard and customized statistical reports regarding your very own golf statistics.
3. Pinpoint the weak areas of your game with precision based on your shot by shot statistics.
4. Improve your game by focusing on the areas of improvement that will lower your score.
5. View the trends in your game in any number of combinations such as round to round, course to course and year to year.

The temporary member ID will be printed on the initial scaled down report that the prospective member receives the first time they try out the system. The information captured from the user to initially grant a temporary ID could be:
1. First Name
2. Last Name
3. Email Address
4. Phone Number

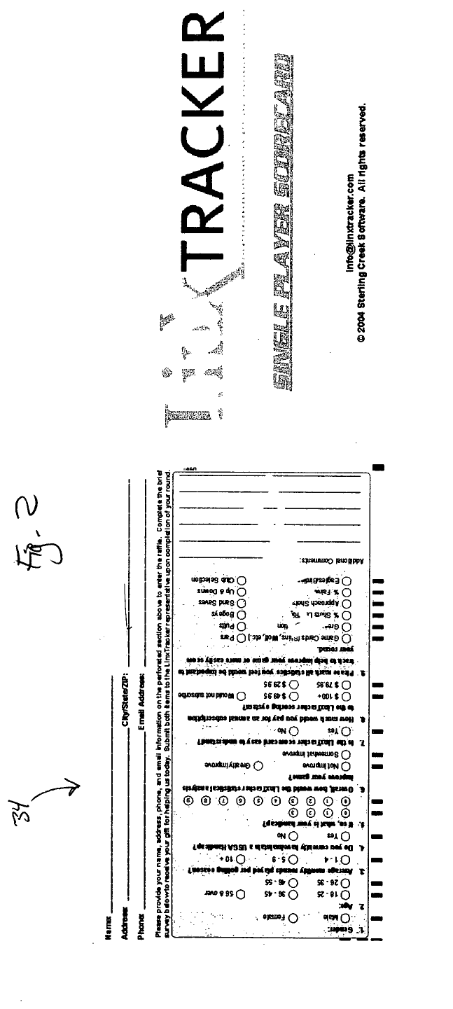

Users will be able to access the system via the website and/or the POS system in the pro shop. The user will have access to all of the reports and functionality describes above once they have been authenticated into the system. Temporary or other users may have the option of completing a questionnaire on a card 34, such as that seen in FIG. 2. Such a card can assist in further revisions to scorecard 10 in order to better service a group of golfers.

The shot recording system also has the ability to allow for access to various reports for participating golf pros. It will be valuable for the golf pro to be able to view statistics related to the golfers who play that pros course. The pro will be able to use this data to pinpoint specific golfers who have deficiencies in their games that the pro may be able to correct through individual golf lessons. The system should give the pro the ability to closely monitor course usage and individual golfer trends to more accurately cater to their customer base. Golf pros are always looking for ways to increase the amount of participation on their courses (more rounds, tournaments, outings, leagues, etc.) and having more relevant data at their fingertips will help them drive more revenue for the club.

Illustratively, standard reports will be available for each round scored via the disclosed system. The standard reports will be comprised of 2 components (online report and hard-copy report). Each report will provide the same data, however, the online report is saved in the central repository for future reference and trend analysis. The hard-copy report is presented to the golfer at the time the round is scored to give immediate feedback and statistics on that rounds performance. The standard report can provide such data as;
Number (%) of fairways hit
Number (%) of pars
Number (%) of birdies
Number (%) of bogies
Number (%) of penalties
Number (%) of putts
Sand saves (up & downs)
Greens in regulation (%)
Number (%) of shots left
Number (%) of shots right

Custom reports will be available for the individual via the website. The user will have the option to select many different options in order to run custom reports and trend analysis against their round data. This trend analysis will become increasingly important as the user adds more and more round data to the central repository.

The Pro will have the ability to run standard and custom reports (via the website) related to specific individuals (providing the individuals consent to the pro having access to their round data) and related to their golf club as a whole. This will allow the pro to run specific trend analysis reports and tailor promotions and offerings to maximize participation at their golf club.

Standard and custom tournament result reports will also illustratively be available via the system. These reports will allow pros to quickly and easily verify tournament, outing and league results and report these results in a timely manner to all participants. This reporting capability will save the pro a tremendous amount of management time that would otherwise be spent manually tabulating and accumulating golf scores for the various tournaments, outings and leagues. Leaderboards can be automatically generated and communicated to the participants and all data has an audit trail based on the time it was scanned and accepted into the system.

The POS units that will be on location at the various golf clubs around the country can be branded with certain partner logos/promotions as the units will have some vacant space around the touch screen, scanner and printer devices. This vacant space will become valuable advertising space as more and more membership subscriptions are sold and more people access the system every day.

Point of Sale (POS) advertising opportunities are available in more traditional means (placards, brochures, banners, table displays, etc.) for display in the pro shop and/or retail locations.

Dynamic advertising opportunities are available via the touch screen monitor. Via batch or real time transmission, the system will be able to update the remote terminals to display the relevant marketing messages for up to the minute control over the messages being broadcast to users. There will be additional opportunities to print coupons for discounts and/or other incentives to users via the statistical reports provided to users of the system.

The technology will be comprised of a number of different hardware components such as a touch screen monitor, magnetic card reader, thermal printer (or other output device), scanner and/or other input device, golf card, network connectivity (Internet), website published to the Internet, central database and necessary hardware, and all applicable cables/wiring and other connectivity. The specific areas are detailed below.

A touch screen monitor may be used for convenience to the user to aid in the process of inputting the user's score after they play their round. The touch screen monitor can be of varying sizes as the amount of data shown to the user in the pro shop is limited (full functionality and data will be available to the user via the website and/or central data repository). The illustrative touch screen monitor 18 shown in FIG. 3 is the Micros Workstation 4 (available at http://www.micros.com). Illustratively, an integrated magnetic card reader is disposed on the right hand side.

This type of input device will allow the user to input various entries into the system by touching the screen at the appropriate places to indicate their responses to specific user directed questions. This method will allow for the associated software to be as flexible as possible as additional functionality can be built into the software while the hardware can remain the same.

Types of information the user can be prompted for, and respond to via the touch screen input device include: handicap, what tee the golfer played from, how many holes the golfer played, what golf ball (manufacturer like Nike, Taylor Made, etc.) the golfer played, what clubs the golfer uses (Callaway, Cleveland, Ping, etc.), and others. Because the software controls the presentation and data capture related to the system, inherently there is flexibility to change the data capture to adapt as the game of golf changes over time.

The illustrative system will also have a method to output data to the user at the point of sale (where the user scans their completed scorecard). This output can be any kind of printer or other device that will give the user an immediate reflection of their activity for that day. Initially, the system will have a thermal based printing device much like a receipt printer in a grocery store. This will allow for very quick printing of the golfer's round summary and statistics for that day's activity. This round summary will give all vital round statistics per the golfer's preference and will allow the golfer to walk away from the golf course with a printed record of that day's activity. The illustrative thermal printer 16 shown in FIG. 3 is the Epson TM-T88111 printer.

Additional output options at the point of sale may include the option to ‘beam’ the round data to a person's PDA (Personal Digital Assistant) or wireless phone from terminal 18 via infrared, or printing a hard copy via a standard sized printer, etc.

The illustrative system automatically captures relevant data related to a person's golf round to provide statistical analysis and trend analysis over time. Illustratively, the data capture is accomplished via a scanner 12 at the point of sale. Such a scanner 12 may be purchased from the Chatsworth Data Corporation, as the model OMR 1102 Desktop Optical Mark Reader with Visible Red capabilities (reads black or blue marks). All information for the OMR 1102 scanners can be found at http://www.omrsys.com/pdf_doc_files/OMR1102.pdf. This scanner will allow for golfers to very quickly scan their scorecard 10 and have the scanner automatically read and capture the relevant pieces of data. This scanner (optical mark reader) operates by scanning the card for marks which have been made in pre-set areas marked in a red background and outline. The software code used with the system would understand, read and capture the relevant marks and turns the marks into usable data for the golfer.

There are other scanners and optical mark readers that can be integrated with the system such as the Chatsworth Data Corporation OMR 1102 Desktop Optical Mark Reader with Infra Red Capabilities (capable of reading no. 2 pencil marks). This reader would permit alternative scorecards to be used, such as those with backgrounds other than the red color that is necessary for the Visible Red model.

The technology also exists to recognize written characters in scanned images. This allows the system to use any scanning solution on the market that will capture the entire image (could be the standard issue golf card at any pro shop). Once an image is scanned into the system, the software could recognize the characters as written by the each individual.

Another method of input for the user includes touch screen or keyboard entry at the point of sale. This method will also allow the user to quickly make changes to their round data in the instance where the scanner did not pick up every unique piece of data that it should have recognized, or if extra data not present on the scorecard is necessary to capture in order to appropriately score the golfer's round (what tee box the golfer played from, etc.).

The system can also be adapted to accept Radio Frequency, Infra Red, or other wireless connection methods (Bluetooth, etc.) to pull in data from a golfer's PDA (Personal Digital Assistant), mobile phones etc. In the event that the golfer would like to score their round using a device rather than the scorecard 10, the system is able to support alternate data inputs.

Illustratively, a scorecard 10 may have a logo and instructions to the golfer on one side of the card and specific hole information on the other side. There is a perforated section at the top to allow the golfer to write in their score and easily track their progress throughout their round as they play. The golfer scores each shot in succession by marking the appropriate area on the golf card. Shots 1-7 allow the golfer to track shots taken to reach the green. Specific entries include “G/F” if the golfer hit the Green or the Fairway, “L” if the shot went to the left rough, “R” if the shot went to the right rough, and “P” if the golfer received a penalty on the specific shot. The last shot taken from the fairway or approach to put the golfer on the green will be indicated by the golfer marking “G/F” to show they are now on the green. Once on the green the golfer can indicate how many putts they have by marking a single number 1, 2, 3, or 4, or multiple numbers if necessary (if the golfer happens to have 5 putts on a particular hole, the golfer may indicate so by filling in both a 4 and a 1 in the appropriate area for that hole). The golfer may also indicate whether they had a Sand Save or not on any particular hole. A Sand Save occurs when a golfer chips out of the sand and the ball goes directly into the hole or the golfer only takes one putt to complete the hole.

An optional area 30 of the card (shown in FIG. 1) has been provided for golfers who are interested in tracking their approach data. This area of the card is located at the bottom of the column associated with each hole and is designated with “Appro” for Approach (“L” if the approach shot was long of the green, “S” if the approach shot was short of the green, “←” if the shot was left, and “→” if the shot was right), “Dist.” For Distance to the Green (100, 125, 150, 175 yards) and Club (7, 8, 9, W) to indicate which club was used on the approach to the green. If the golfer went over the green from 150 yards using their 7 iron they would indicate so by marking “L”, “150”, “7”. This data will allow golfers to accurately track their approach shots and view their very own statistics over time in order to pinpoint areas of their game that need specific attention to ultimately lower their score.

An alternative way for the golfer to score each hole is to have the golfer indicate whether they receive a par or indicate how many strokes +/−par they received on a hole. An example is that a golfer who scored a 5 on a par 4 would indicate this by marking “+” and “1” since the golfer score 1 over par.

It is important to remember that this scorecard 10 could capture any kind of desired data. Examples may include a food order from golfers as they are making the turn between holes 9 and 10 (golfer fills out a card with the data related to the food he/she would like and scans the order in at scanner on the course at hole nine, in the clubhouse, etc.), or a gaming card that tracks how many Skins the various players have won throughout the course of the day, or a club selection card that allows the golfer to track not only each shot but what club was selected, the distance and the result of the shot, survey data related to questions posed to a large audience, identification by allowing the golfer to fill in a unique identification code on the care, etc. Summarily, the content of the card can be virtually anything.

There are several options for network connectivity for the system. A golf course could provide our system connectivity via their LAN (Local Area Network) and via an Ethernet connection, or other network topography, if one is available. Additionally, the system could be connected via a dial-up connection to the Internet and/or directly to the central facility. Wireless connectivity is also a feasible option with the use of a wireless card 32, shown in FIG. 3. Such a wireless card 32 is available from Sprint as wireless access card model Sierra Air Card 550, found online at http://www.sprint.com. Such a card 32 may be integrated with the touch screen module. However, appropriate network connectivity can be established via any Internet connection (provided via dial-up, cable modem, DSL, T1, Satellite, Fiber, etc.) and/or direct dial capabilities (dial-up modem, wireless/cellular access).

The illustrative membership website (http://www.linxtracker.com) published via the wide world web (Internet) is the portal to allow LinxTracker users to view the data stored in the central repository. The ability to automatically capture data and seamlessly transmit and replicate that data to a central repository accessible via the Internet allows for automatic and ubiquitous access to the data captured by the system. The remote modules (touch screen monitor system 18) will be formatted with built in replication routines to allow for daily remote replication with the central repository. This replication can be bi-directional (central repository can “push” data to the remote devices such as advertising, etc. as well as “pull” data from the remote devices such as statistical golf round data). The website is structured to be the portal that all users can use to view the historical rounds of data they have input into the system as well as use additional online tools provided by the system to analyze their game. All subscribers will have the ability to login to the system to view their playing history, view/print reports, analyze trends in their games, etc. A central repository (accessible via a website) can also be the central location for users to visit for promotions, discounts on various golf-related merchandise/services, etc. Such a website view and illustrative advertising can be see in view 36, shown in FIG. 3.

should be understood that while the current application is being geared toward the golf industry, the idea of being able to automatically capture data via a card and a scanner is applicable to other industry applications. Examples would be recording patient data for doctor visits, taking a survey at remote locations, making stock trades, etc. Such uses are within the scope of the disclosure.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the spirit and scope of the disclosure as defined by the appended claims.

1. A golf shot tracking system comprising:
a golf scorecard having portions for entry of data to produce entered data;
an input device configured to read entered data from said scorecard to produce read data;
an output device configured to report some or all of the read data to produce selected data; and
a database accessible via a network for storing the selected data to produce a network-accessible database.

2. The system of claim 1, wherein said database is accessible from a plurality of locations.

3. The system of claim 1, wherein said network comprises at least one of an Internet, an intranet, an extranet, a WAN (Wide Area Network), a LAN (Local Area Network), and a VPN (Virtual Private Network).

4. The system of claim 1, wherein said database is configured to store data relating to a golf course at which the data was obtained.

5. The system of claim 1, wherein said database is configured to store data from a plurality of golf courses.

6. The system of claim 1, wherein said scorecard is configured to record data from a single golfer.

7. The system of claim 1, wherein said scorecard is configured to record the data from a plurality of golfers.

8. The system of claim 1, wherein said database is configured to store the data from a plurality of golf courses.

9. The system of claim 1, further comprising an identification device.

10. The system of claim 9, wherein said identification device is one selected from the group comprising a fingerprint scanner, facial recognition technology, a biometric scanner, a magnetic-strip card reader, an RF receiver for receiving signals from an RF transmitter, a signal receiver for receiving signals from a signal transmitter, a scanned identification code on said score card or separate card, bar code identification, and a code input device.

11. The system of claim 1, wherein said input device is at least one selected from the group comprising a scanner, a Personal Digital Assistant, an electronic scoring device, a mobile phone, and a GPS device.

12. The system of claim 1, wherein said output device is at least one selected from the group comprising a printer, a terminal, a computer, a network, a website, an intranet, an extranet, and a display.

13. The system of claim 1, further comprising a processor configured to collect data received from said input device and arrange the data in a pre-determined fashion for outputting with said output device.

14. The system of claim 13, wherein said processor is further configured to direct data to said network-accessible database.

15. A game score tracking system comprising:
a game scorecard having portions for entry of data to produce entered data;
an input device configured to read entered data from said scorecard to produce read data;
an output device configured to report some or all of the read data to produce selected data; and
a database accessible via a network for storing the selected data to produce a network-accessible database.

16. The system of claim 15, wherein said database is accessible from a plurality of locations.

17. The system of claim 15, wherein said network comprises at least one of the Internet, an intranet, an extranet, a WAN (Wide Area Network), a LAN (Local Area Network), and a VPN (Virtual Private Network).

18. The system of claim 15, wherein said database is configured to store data relating to the game venue.

19. The system of claim 15, wherein said database is configured to store data from a plurality of game venues.

20. The system of claim 15, wherein said scorecard is configured to record data from a single game player.

21. The system of claim 15, wherein said scorecard is configured to record data from a plurality of game players.

22. The system of claim 15, wherein said database is configured to store data from a plurality of venues.

23. The system of claim 15, further comprising an identification device.

24. The system of claim 23, wherein said identification device is one selected from the group comprising a fingerprint scanner, facial recognition technology, a biometric scanner, a magnetic-strip card reader, an RF receiver for receiving signals from an RF transmitter, a signal receiver for receiving signals from a signal transmitter, a scanned identification code on said scorecard or separate card, bar code identification, and a code input device.

25. The system of claim 15, wherein said input device is at least one selected from the group comprising a scanner, a Personal Digital Assistant, an electronic scoring device, mobile phone, and a GPS device.

26. The system of claim 15, wherein said output device is at least one selected from the group comprising a printer, a terminal, a computer, a website, an intranet, an extranet, and a display.

27. A method of recording data relating to a golf game comprising the steps of:
inputting said data into a device;
using a processor to arrange said data into a predetermined format;
outputting said formatted data to an output device; and
transmitting one of said data and said formatted data to a central repository.

28. The method of claim 27, wherein a scanner is used to input said data into said device.

29. The method of claim 27, wherein at least one of a PDA, GPS device, and a mobile phone is used to input said data into said device.

30. The method of claim 27, wherein said output device comprises at least one of a printer, a terminal, a computer display, a website, an intranet, and an extranet.

31. The method of claim 27, further comprising an additional step of analyzing said data in said central repository.

32. The method of claim 27, further comprising an additional step of permitting a golf pro to access said central repository.

33. The method of claim 27, further comprising an additional step of permitting access to said central repository by a subscriber to a service.

34. The method of claim 27, wherein one of said data and said formatted data is transmitted over a network to said central repository.

35. The method of claim 34, wherein said network comprises at least one of the Internet, an intranet, an extranet, a Wide Area Network, a Local Area Network, and a Virtual Private Network.

36. The method of claim 27, wherein said central repository is accessible via a network.

37. The method of claim 36, wherein said network comprises at least one of the Internet, an intranet, an extranet, a Wide Area Network, a Local Area Network, and a Virtual Private Network.
